(19) United States
(12) Patent Application Publication
(10) Pub. No.: US 2006/0168883 A1
(43) Pub. Date: Aug. 3, 2006

(54) Flower pot and/or holder therefor having an integral drain apparatus

(76) Inventors: Harry R. Brutsche III, Dallas, TX (US); Edwin S. Smith, Austin, TX (US); Matthew A. Brutsche, Austin, TX (US)

Correspondence Address: CARR LLP, 670 FOUNDERS SQUARE, 900 JACKSON STREET, DALLAS, TX, 75202, US

(21) Appl. No.: 11/397,167

(22) Filed: Apr. 4, 2006

Related U.S. Application Data
(62) Division of application No. 10/694,067, filed on Oct. 27, 2003.

(51) Int. Cl. A01G 9/04

(52) U.S. Cl. 47/71

(57) ABSTRACT

A planter system having a self-draining tray for supporting a flower pot or planter in an area that receives regular watering, the tray having flat, horizontal surfaces formed by ribs supporting the flower pot or planter and another surface below the ribs directing excess water to a drain. The drain allows excess water to be removed from the tray regardless of how much water is received by the flower pot or planter. The drain may be connected to a hose or other tubing to conduct water away from the planter system. The self-draining tray may be incorporated integrally with a flower pot as a combined planter system. Drain tubing and/or drain/supply tubing may be fabricated having a particular profile.

### TECHNICAL FIELD

The invention relates generally to flower pots or planters and, more particularly, to drainage methods and apparatus.

### BACKGROUND

Water is typically provided to a flower pot or planter either from rainfall, by hand or by the use of an automatic sprinkler system. Hand watering can be done either by pouring the water in from a container or water hose or by filling a reservoir as described in U.S. Pat. No. 4,339,891. In all cases any water that is not absorbed by the soil flows through the drain hole in the planter and typically into a saucer or tray located under the planter. The saucer is used to contain the excess water and the water is removed from the saucer either manually or more typically from evaporation.

This arrangement has two major disadvantages. The first is if the saucer cannot contain all of the water draining from the planter, the excess water overflows onto the surrounding surface causing stains on the surrounding surface from mineral deposits and from the growth of algae and other organic materials. The second disadvantage is the standing water in the saucer which promotes the growth of organic materials and provides hatching grounds for disease carrying insects such as mosquitoes.

Therefore, a need exists for a method and an apparatus for managing excess water applied to a flower pot or planter, for draining excess water from the flower pot or planter, and for conducting excess water away from the flower pot or planter. A further need exists for a method and an apparatus for doing so without wetting or soiling a surface surrounding the flower pot or planter.

### SUMMARY

The present invention achieves these and other objectives using a planter system having an integral drain apparatus that can be connected to a drainage tube for conducting excess water away from the planter system. The planter system has an upward-facing interior surface with a drain formed therein and a conduit that conducts excess water to an exit. A fitting provided at the exit connects the planter system to a drainage tube.

In one aspect of the invention, a tray for supporting a planter has a drain formed in the bottom thereof and a passageway connecting the drain to an exit. A fitting may be provided at the exit for connecting a drainage tube.

In another aspect of the invention, the bottom of the tray has a sloping surface that conducts water to the drain. One or more raised surfaces may be provided to support a planter above the sloping surface.

In another aspect of the invention, a planter has a drain formed in the bottom thereof and a passageway connecting the drain to an exit. A fitting may be provided at the exit for connecting a drainage tube.

In another aspect of the invention, the planter has a sloping surface that conducts water to the drain.

In another aspect of the invention, the drainage tubes have a low-profile, generally curved upper surface, a generally planar lower surface, and a hollow passageway therethrough for conducting excess water away from a tray or planter.

In another aspect of the invention, the drainage tube system has a second hollow passageway for supplying water to the planter from a water source such as a sprinkler system.

In another aspect of the invention, the drainage tubes are provided with fittings for connecting various lengths of drainage tubes together.

In another aspect of the invention, the drainage tubes are selected from among the group of straight-section drainage tubes and corner drainage tubes. The corner drainage tubes may be flat-corner drain tubes or vertical-corner couplers. The vertical corner couplers may be inside corner couplers or outside corner couplers.

In another aspect of the invention, a planter system has a planter formed as a container having a drain hole and a tray for supporting the planter, the tray being formed as a container having a drain and a passageway connecting the drain to an exit. A fitting may be provided at the exit for connecting a drainage tube.

In another aspect of the invention, the tray has a sloping surface that conducts water to the drain. One or more raised surfaces may be provided to support a planter above the sloping surface.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A is a perspective view of a planter system;

FIG. 1B is a sectional view of a tray taken along lines 1B-1B of FIG. 1A;

FIG. 2A is a perspective view of a planter system;

FIG. 2B is a sectional view of a tray taken along lines 2B-2B of FIG. 2A;

FIG. 3A is a top perspective view of a tray according to another embodiment;

FIG. 3B is a bottom perspective view of the tray shown in FIG. 3A;

FIG. 3C is a plan view of the tray shown in FIG. 3A;

FIGS. 3D and 3E are sectional views of the tray taken along lines 3D-3D and 3E-3E in FIG. 3C;

FIG. 4A is a perspective view of a planter;

FIG. 4B is a sectional view of the planter taken along lines 4B-4B in FIG. 4A;

FIG. 5A is a perspective view of a planter according to another embodiment;

FIG. 5B is a sectional view of the planter taken along lines 5B-5B in FIG. 5A;

FIG. 6A is a perspective view of a planter and a drainage tube system;

FIG. 6B is a sectional view of a drainage tube taken along lines 6B-6B in FIG. 6A;

FIG. 6C is an exploded view, in perspective, of an extended configuration of the drainage tube system;

FIG. 7 is a cross-sectional view of a planter according to another embodiment;

FIG. 8 is a cross-sectional view of a planter system according to another embodiment;

FIG. 9A is a perspective view of a planter and a two-way drain/supply tube system; and

FIG. 9B is a sectional view of a drain/supply tube taken along lines 9B-9B in FIG. 9A.

### DETAILED DESCRIPTION

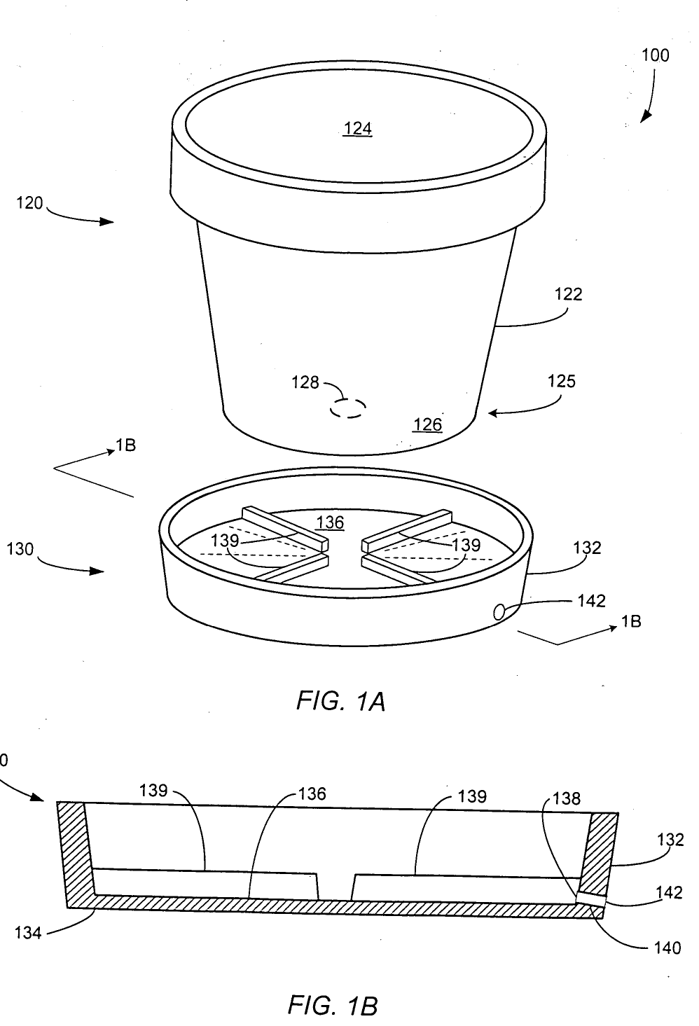

Referring to FIG. 1A of the drawings, the reference numeral 100 generally designates a planter system embodying features of the present invention. The planter system 100 includes a flower pot 120 and a saucer or tray 130. The flower pot 120 may be of conventional configuration, having a side wall 122 formed as a conical section and tapering from an open upper end 124 towards a lower end 125, the lower end being closed by a bottom 126 having a drain hole 128 formed therein. The flower pot 120 is normally filled with a planting medium such as potting soil and has rooted therein a plant such as a flower, herb, vegetable or other such botanical organism.

The tray 130 may be generally circular and of sufficient diameter to receive the lower end 125 of the flower pot 120. The tray 130 is typically provided to retain water that may discharge through the drain hole 128 when the plant is watered, and is therefore normally configured as having a circular bottom 134 (shown in FIG. 1B) and a generally cylindrical sidewall 132 extending upwardly from the bottom 134 of the tray to form a container. The tray 130 is formed with an upper surface 136 and a plurality of supporting ribs 139 that support the flower pot 120 above the upper surface 136.

Referring now to FIG. 1B, the tray 130 is shown in a sectional view taken along lines 1B-1B in FIG. 1A. A drain 138 is formed in the tray 130 at or below the level of the upper surface 136. A conduit 140 formed within the body of the tray 130 connects the drain 138 to an exit 142 formed in the sidewall 132. Water discharged from drain 128 (FIG. 1A) in flower pot 120 is collected in drain 138 and conducted through conduit 140 towards the exit 142. Supporting ribs 139 support the flower pot 120 above the upper surface 136 so that the flow of water towards drain 138 is not impeded. The exit 142 may be provided with a fitting (not shown) for connecting a hose or other tubing to conduct water away from the tray 130.

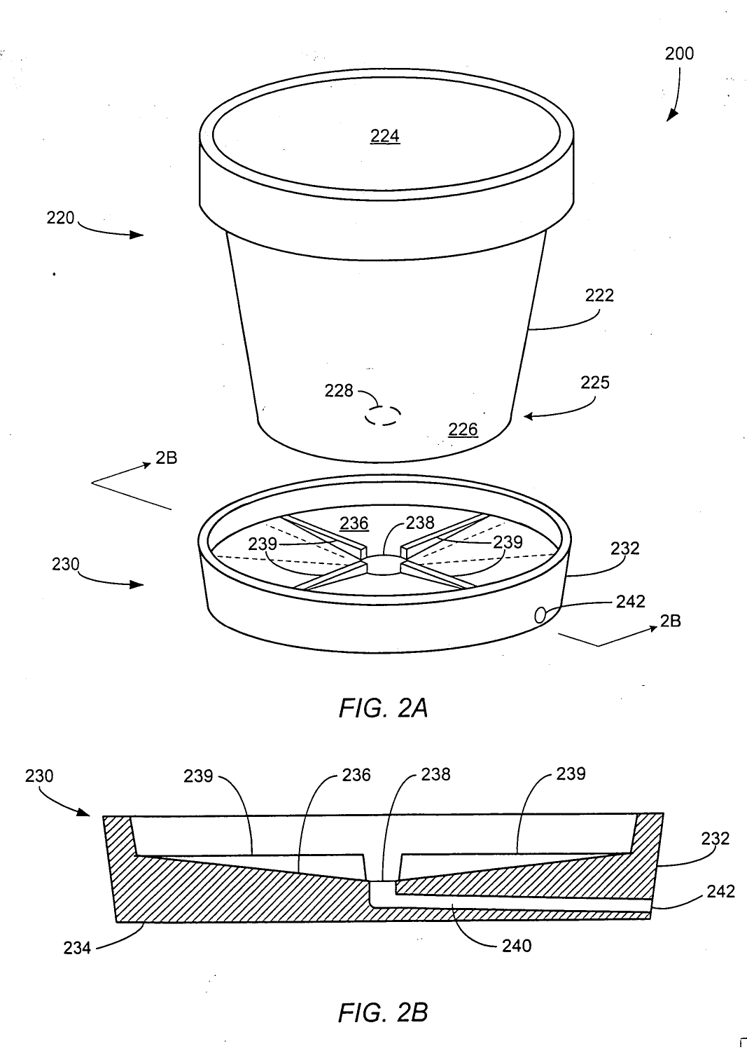

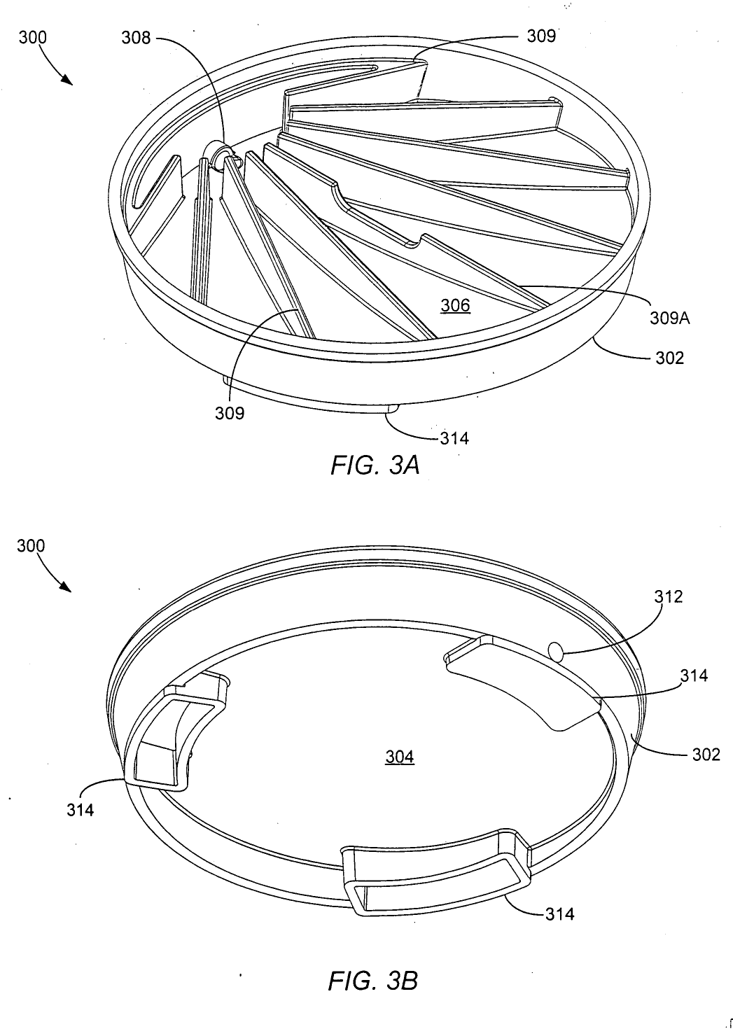

Referring to FIG. 2A of the drawings, the reference numeral 200 generally designates a planter system embodying additional features. The planter system 200 includes a flower pot 220 and a saucer or tray 230. The flower pot 220 may be of conventional configuration, having a side wall 222 formed as a conical section and tapering from an open upper end 224 towards a lower end 225, the lower end being closed by a bottom 226 having a drain hole 228 formed therein. The flower pot 220 is normally filled with a planting medium such as potting soil and has rooted therein a plant such as a flower, herb, vegetable or other such botanical organism.

The tray 230 may be generally circular and of sufficient diameter to receive the lower end 225 of the flower pot 220. The tray 230 is typically provided to retain water that may discharge through the drain hole 228 when the plant is watered, and is therefore normally configured as having a circular bottom 234 (shown in FIG. 2B) and a generally cylindrical sidewall 232 extending upwardly from the bottom 234 of the tray to form a container. The tray 230 is formed with a sloping upper surface 236 that conducts water towards a drain 238 formed in the center of the sloping surface 236, and a plurality of supporting ribs 239 that support the flower pot 220 above the sloping surface 236.

Referring now to FIG. 2B, the tray 230 is shown in a sectional view taken along lines 2B-2B in FIG. 2A. A conduit 240 is formed within the body of the tray 230. The conduit 240 connects the drain 238 to an exit 242 formed in the sidewall 232. Water discharged from drain 228 (FIG. 2A) in flower pot 220 is collected in drain 238 and conducted through conduit 240 towards the exit 242. The sloping surface 236 directs water collected within the tray towards the drain 238 for passage through conduit 240 towards the exit 242. Supporting ribs 239 support the flower pot 220 above the sloping surface 236 so that the flow of water towards drain 238 is not impeded. The exit 242 may be provided with a fitting (not shown) for connecting a hose or other tubing to conduct water away from the tray 230.

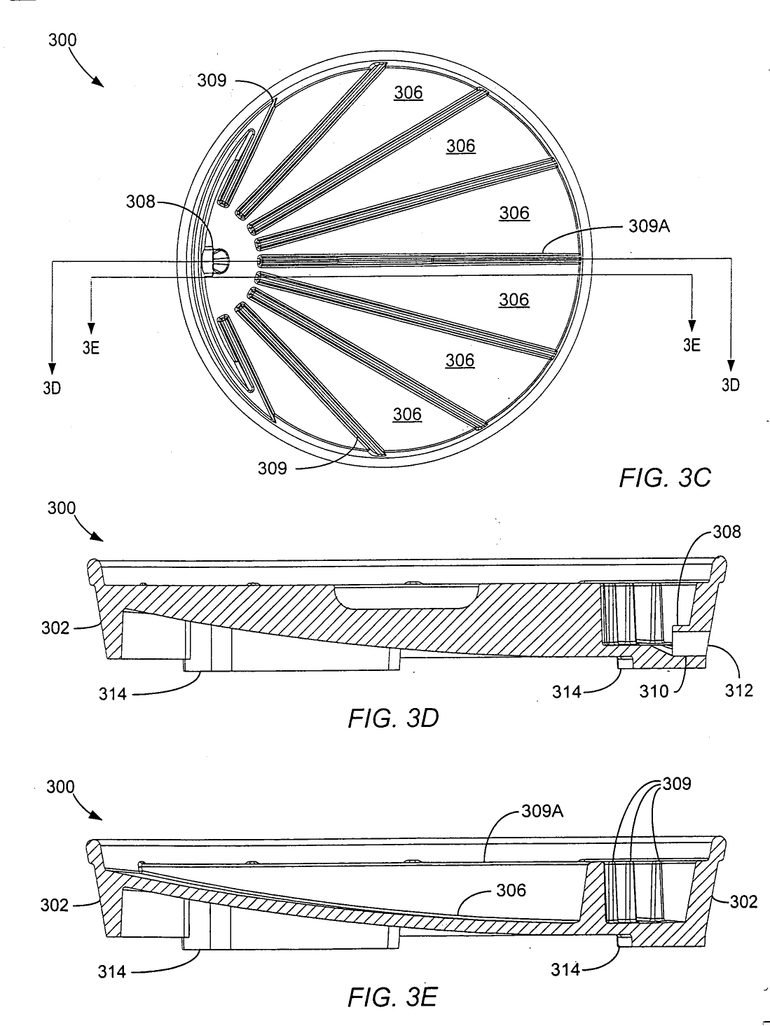

In an alternate embodiment shown in FIGS. 3A-3E, a tray 300 is configured as having a generally circular side wall 302 and a circular bottom 304 integral about its peripheral edge with the side wall 302. The tray 300 is formed with a sloping surface 306 that conducts water towards a drain 308 formed at one side of the tray 300 where the sloping surface 306 meets the side wall 302. A plurality of supporting ribs 309 extend radially from the vicinity of the drain 308. A conduit 310 is formed in the side wall 302 and connects the drain 308 to an exit 312 formed in an exterior surface of the side wall 302. The tray 300 may be supported above a surface (not shown) such as a patio or deck by feet 314 formed in the body of the tray 300.

As shown in FIG. 3C, the drain 308 is formed at one side of the tray 300 and supporting ribs 309 extend radially from the vicinity of the drain 308. The sloping surface 306 is therefore sloped downward in the direction of the drain 308 so as to conduct water collected in the tray 300 towards the drain 308. FIG. 3D is a sectional view of the tray 300 taken along lines 3D-3D in FIG. 3C, a section through the center of the drain 308 and the central supporting rib 309A. FIG. 3E is a sectional view of the tray 300 taken along line 3E-3E in FIG. 3C, a section through the tray 300 slightly to the side of drain 308 and the central supporting rib 309A. As shown in FIG. 3E, the sloping surface 306 slopes downward and conducts water towards the vicinity of drain 308. As shown in FIG. 3D, a conduit 310 connects drain 308 to an exit 312 formed in an exterior surface of side wall 302.

A saucer or tray, such as tray 130, tray 230, or tray 300, according to the present invention may be fabricated of any waterproof material such as, for example, a plastic material. Suitable plastic materials include polypropylene, polyurethane, polycarbonate, or UBS. Any other waterproof material would also be suitable. The tray may also be formed into different shapes besides generally circular, such as square, rectangular, triangular; elliptical or an irregular shape.

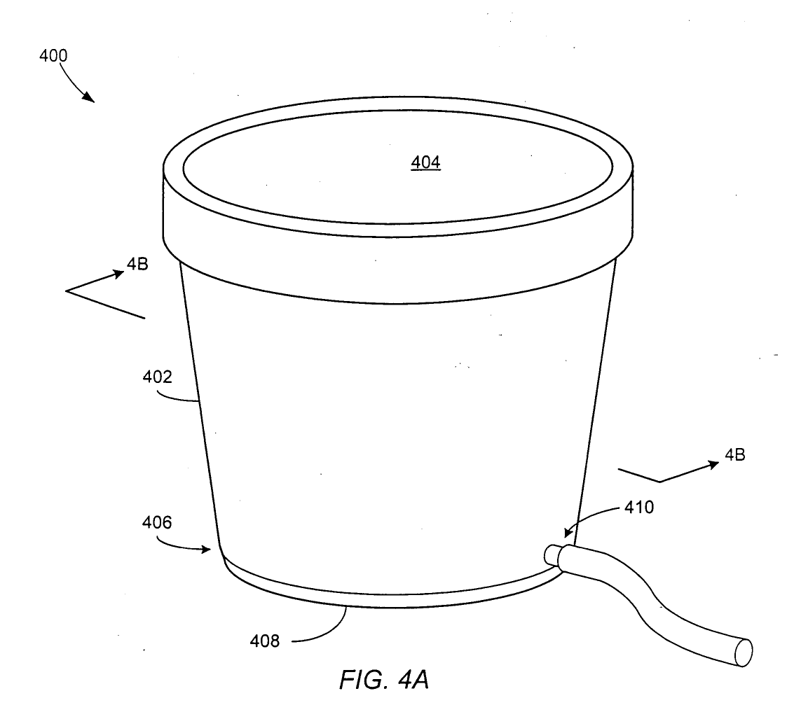

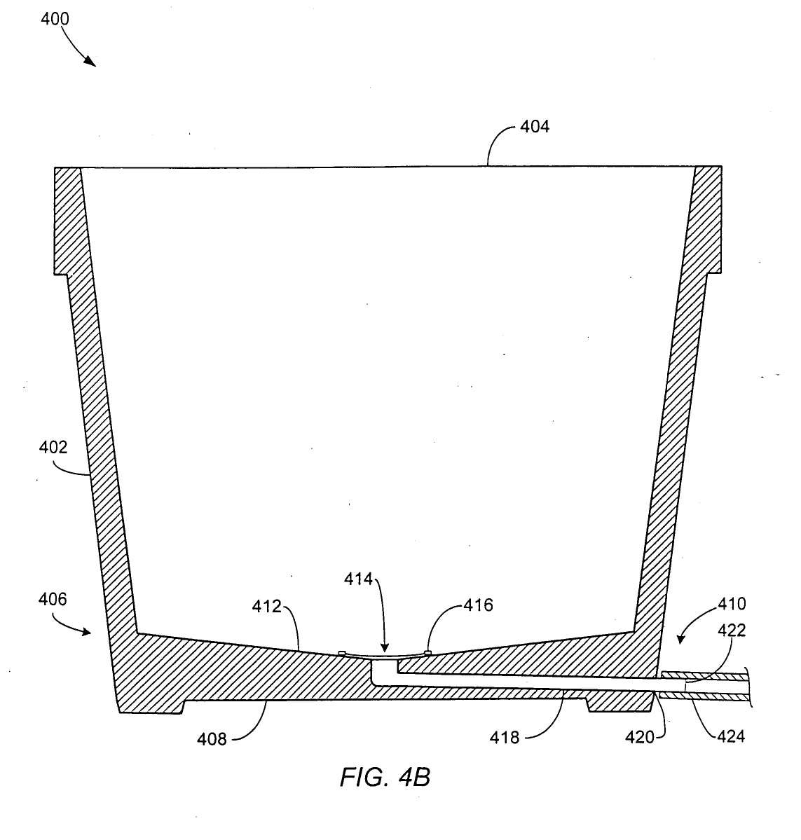

Referring now to FIGS. 4A and 4B, a planter 400 incorporates the integral drain feature of tray 30 (FIGS. 1 and 2) with the general features of flower pot 20 (FIGS. 1 and 2). As shown in FIG. 4A, the planter 400 is configured as having a side wall 402 formed as a conical section and tapering from an open upper end 404 towards a lower end 406, the lower end being closed by a circular bottom 408 integral about its peripheral edge with the side wall 402. The planter 400 is normally filled with a planting medium such as potting soil (not shown) and has tooted therein a plant such as a flower, herb, vegetable or other botanical organism (not shown). A drain apparatus 410 is provided at the lower end 406 of the planter 400.

Referring now to FIG. 4B, the planter 400 is shown in a sectional view taken along the lines 4B-4B in FIG. 4A. The lower end 406 of the planter 400 is formed with a sloping surface 412 that conducts water towards a drain 414 formed in the center of the sloping surface 412. As the planter is normally filled with soil, it may be preferable to include a screen 416 covering the drain 414 to retain the soil and to allow excess water to flow into the drain 414. A conduit 418 is formed within the body of the lower end 406 of the planter 400. The conduit 418 connects the drain 414 to an exit 420 formed in the side wall 402 at the lower end 406 of the planter 400. Water is collected in the drain 414, conducted through conduit 418 towards the exit 420. A fitting 422 installed in the exit 420 facilitates connection of a hose or flexible tube 424 to conduct water away from the planter 400.

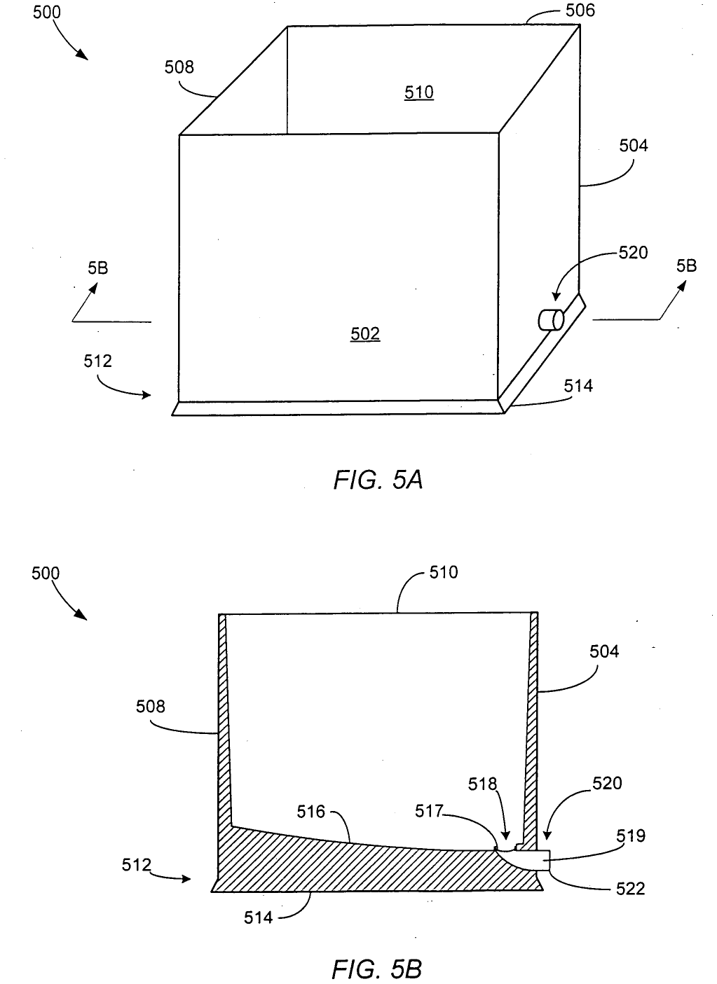

In an alternate embodiment shown in FIGS. 5A and 5B, a planter 500 is configured as being generally rectangular or square and having an integral drain apparatus similar to the drain apparatus shown in FIGS. 3A-3E and FIGS. 4A-4B. As shown in FIG. 5A, a planter 500 is configured as being generally rectangular or square, having a front wall 502, a first side wall 504, a rear wall 506, and a second side wall 508, each of the walls 502, 504, 506, and 508 being integral along peripheral edges thereof with adjacent walls. The planter 500 may have straight walls as shown or may taper inwards from an open end 510 towards a lower end 512, the lower end 512 being closed by a rectangular or square bottom 514 integral about its peripheral edge with walls 502, 504, 506, and 508. The planter 500 forms a water-tight container except for the provision of a drain apparatus, of which an exit 520 is shown provided at the lower end 512 of the planter 500.

Referring now to FIG. 5B, the planter 500 is shown in a sectional view taken along the lines 5B-5B in FIG. 5A. The lower end of the planter 500 is formed with a sloping surface 516 that conducts water towards a drain 518 formed at the side of the sloping surface 516. A screen 517 may be placed over the drain 518 to retain soil and to allow excess water to flow into the drain 518. A conduit 519 connects the drain 518 to an exit 522 formed in an exterior surface of side wall 504. The exit may be provided with a fitting for attaching a hose or tube to conduct water away from the planter 500.

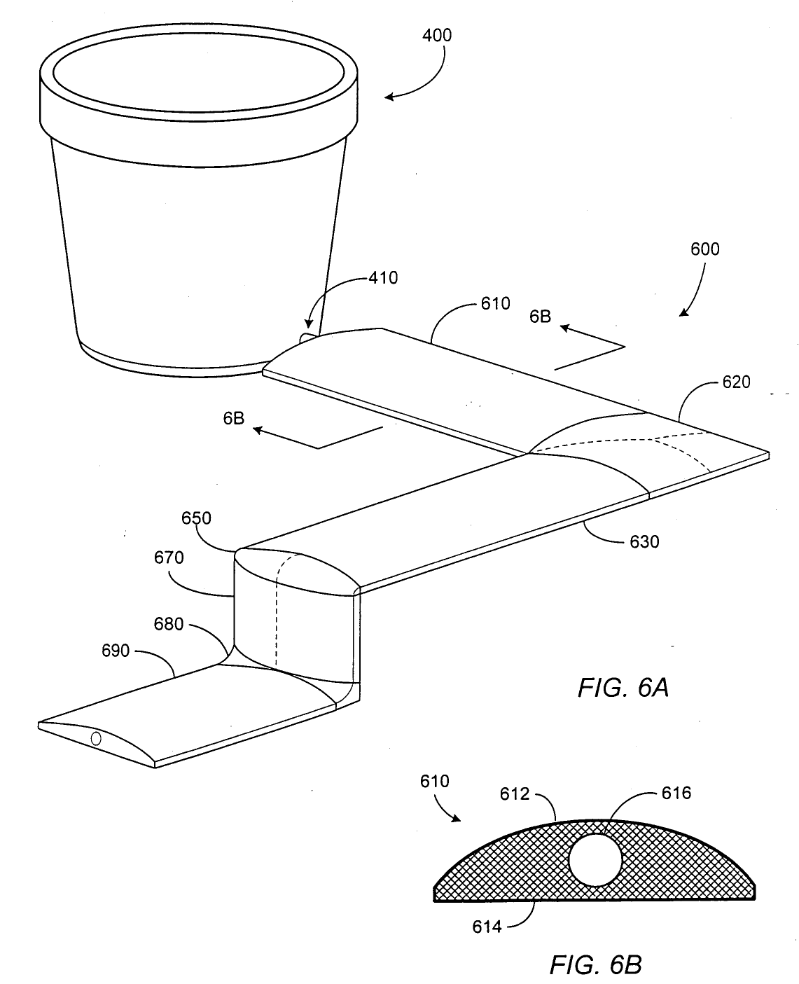

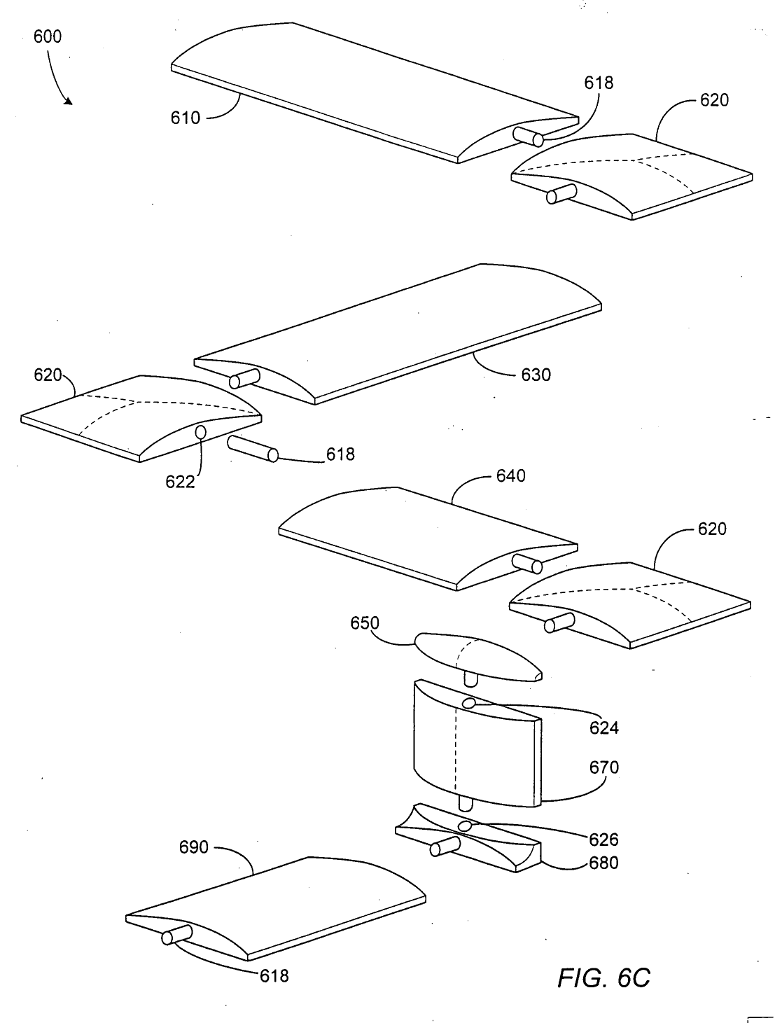

Referring now to FIGS. 6A, 6B and 6C, the planter 400 is shown having connected thereto a drainage tube system 600 having a number of straight-section drain tubes of varying lengths interconnected to corner couplings by a fitting 618. A drain tube 610 is shown in FIG. 6B in a sectional view taken along the lines 6B-6B in FIG. 6A, and is configured as having a low-profile, curved upper surface 612, a generally planar lower surface 614, and a hollow passageway or conduit 616 in the center. The drain tube 610 is preferably fabricated from extruded rubber or plastic and is provided with fittings for attaching additional drain tubes.

As shown in FIG. 6A, a first straight-section drain tube 610 is connected to the planter 400 at the drain apparatus 410. The first drain tube 610 is coupled to a second drain tube 630 by a 90-degree flat-corner drain tube 620. The second drain tube 630 is coupled to a third drain tube 670 by an outside vertical-corner coupler 650. The third drain tube 670 is coupled to a fourth drain tube 690 by an inside vertical-corner coupler 680.

Referring now to FIG. 6C, the drainage tube system 600 is shown in an exploded view of an extended configuration of sections of the system as being disconnected from one another. A 90-degree flat-corner drain tube 620 has an interior passageway 622 into which the fitting 618 may be inserted for coupling the flat-corner drain tube 620 to a straight-section drain tube 640. Each section of drain tube is similarly constructed, having a hollow passageway or conduit for conducting water through the drain tube. As shown in FIG. 6C, the flat-section drain tube 610 is provided with a fitting 618 for connecting to a flat-corner drain tube 620. The flat-corner drain tube 620 is provided with a fitting for connecting to the next straight-section drain tube 630. The straight-section drain tube 630 is provided with a fitting for connecting to the flat-corner drain tube 620. The flat-corner drain tube 620, as described above, connects to a flat-section drain tube 640. The flat-section drain tube 640 is also provided with a fitting for connecting to the next flat-corner drain tube 620. The flat-corner drain tube 620 is provided with a fitting for connecting to an outside vertical-corner coupler 650. The outside vertical-corner coupler 650 is provided with a fitting for connecting to a flat-section drain tube 670 at passageway 624. The flat-section drain tube 670 is provided with a fitting for connecting to an inside vertical-corner coupler 680 at passageway 626. The inside vertical-corner coupler 680 is provided with a fitting for connecting to a flat-section drain tube 690. The flat-section drain tube 690 is provided with a fitting 618 for connecting to additional sections of drain tube, as required.

The drain tubes, the 90-degree flat-corner drain tubes and the vertical-corner couplers are all preferably fabricated from similar materials such as extruded rubber or plastic and are provided with interconnecting fittings for attaching together various lengths of straight drain tubes and corners. The fittings may be removable and insertable as shown in FIG. 6C, or the fittings may be molded into one end of the section of drain tube. Corner-section drain tubes may be fabricated to conduct water at any angle, such as the 90-degree angles as shown in FIGS. 6A and 6C, or at any other angle, such as 45 degrees, 30 degrees, and the like. Vertical-corner couplers may also be constructed to turn any desired angle, such as 90 degrees, as shown in FIGS. 6A and 6C, or at any other angle, such as 45 degrees, 30 degrees, and the like. The drainage tube system 600, so constructed, may be used to conduct water away from a planter across walkways or open areas, around corners, over ledges or down steps. The profile of each section of drain tube is sufficiently low to walk over easily and is shaped so as to lie flat on the surrounding surface. The plastic or rubber material from which the drain tubes are fabricated are preferably colored to match the surrounding surface materials, such as concrete, brick pavers, patio flagstones, wooden decks and the like.

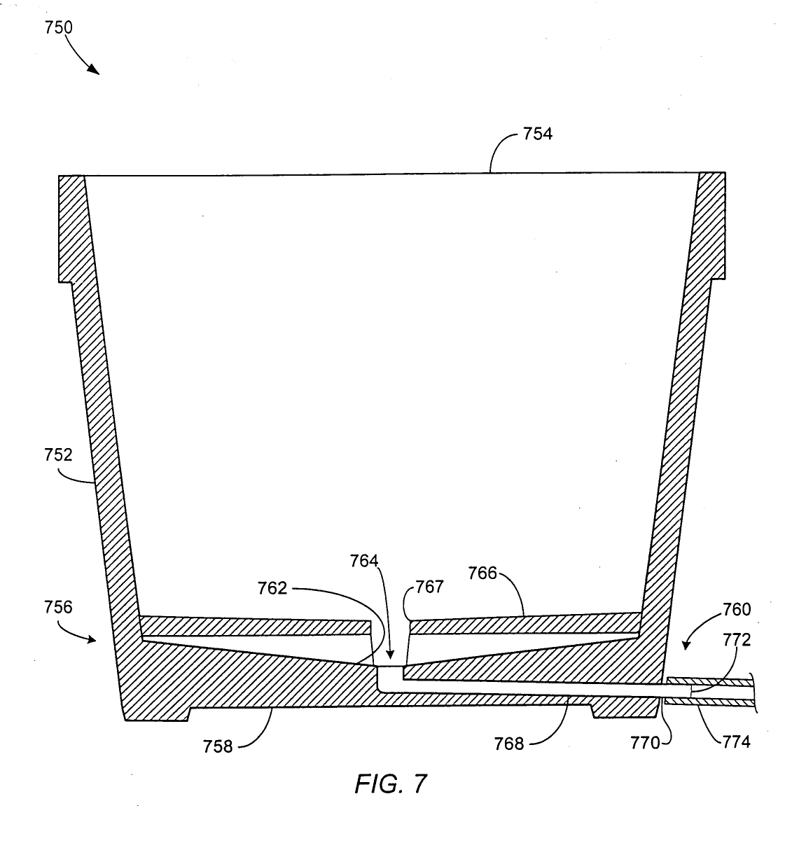

Referring now to FIG. 7, a planter 750, according to another aspect of the invention, having an integral drain apparatus 760, is shown in a cross-sectional view. The planter 750 may be configured as a generally circular planter, as a rectangular or square planter, or as any other regular or irregular shape. The planter 750 is configured as having a side wall 752 tapering from an open upper end 754 towards a lower end 756, the lower end being closed by a circular bottom 758 integral about its peripheral edge with the side wall 752. The planter 750 is normally filled with a planting medium such as potting soil (not shown) and has rooted therein a plant such as a flower, herb, vegetable or other botanical organism (not shown). A drain apparatus 760 is provided at the lower end 756 of the planter 750. The lower end 756 of the planter 750 is formed with a sloping surface 762 that conducts water towards a drain 764 formed in the center of the sloping surface 762. The planter 750 is provided with a false bottom 766 for supporting soil above the sloping surface 762. The false bottom 766 may be molded into the body of the planter or may be formed separately and inserted into the planter. The false bottom 766 has formed therein a drain hole 767 for allowing excess water to flow into the drain 764. A conduit 768 is formed within the body of the lower end 756 of the planter 750. The conduit 768 connects the drain 764 to an exit 770 formed in the side wall 752 at the lower end 756 of the planter 750. Water is collected in the drain 764 and conducted through conduit 768 towards the exit 770. A fitting 722 installed in the exit 770 facilitates connection of a hose or flexible tube 774 to conduct water away from the planter 750.

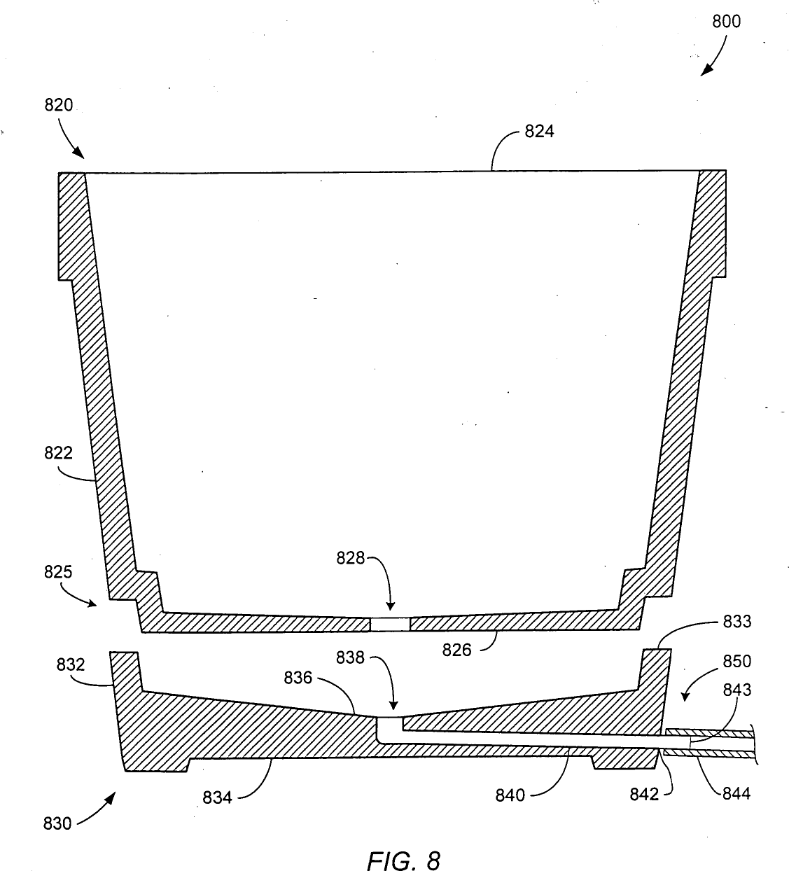

Referring now to FIG. 8, a planter system 800, according to another aspect of the invention, is shown having a flower pot 820 and a tray 830. The planter system 800 may be configured as generally circular, rectangular or square, or as any other regular or irregular shape. The flower pot 820 has a side wall 822 tapering from an open upper end 824 towards a lower end 825, the lower end being closed by a bottom 826 having a drain hole 828 formed therein. The flower pot 820 is normally filled with a planting medium such as potting soil and has rooted therein a plant. The tray 830 receives the lower end 825 of the flower pot 820 and retains excess water that may discharge through the drain hole 828.

The tray 830 is configured as having a sidewall 832 and a bottom 834 integral about its peripheral edge with the sidewall 832. The tray 830 is formed with a sloping surface 836 that conducts water towards a drain 838 formed in the center of the sloping surface 836. The bottom 826 of the flower pot 820 is made slightly smaller than the sidewall 832 of the tray 830 so that sidewall 832 of the tray 830 fits sidewall 822 of the flower pot 820 in interlocking fashion, thereby supporting the flower pot 820 above the sloping surface 836. A top surface 833 of tray side wall 832 forms a raised surface for supporting planter 820 above the sloping surface 836.

A conduit 840 is formed within the body of the tray 830. The conduit 840 connects the drain 838 to an exit 842 formed in the sidewall 832. Water discharged from drain 828 in flower pot 820 is collected in drain 838 and conducted through conduit 840 towards the exit 842. The sloping surface 836 directs water collected within the tray towards the drain 838 for passage through conduit 840 towards the exit 842. Side wall 832 supports the flower pot 820 above the sloping surface 836 so that the flow of water towards drain 838 is not impeded. The exit 842 is provided with a fitting 843 for connecting a hose or other tubing to conduct water away from the tray 830.

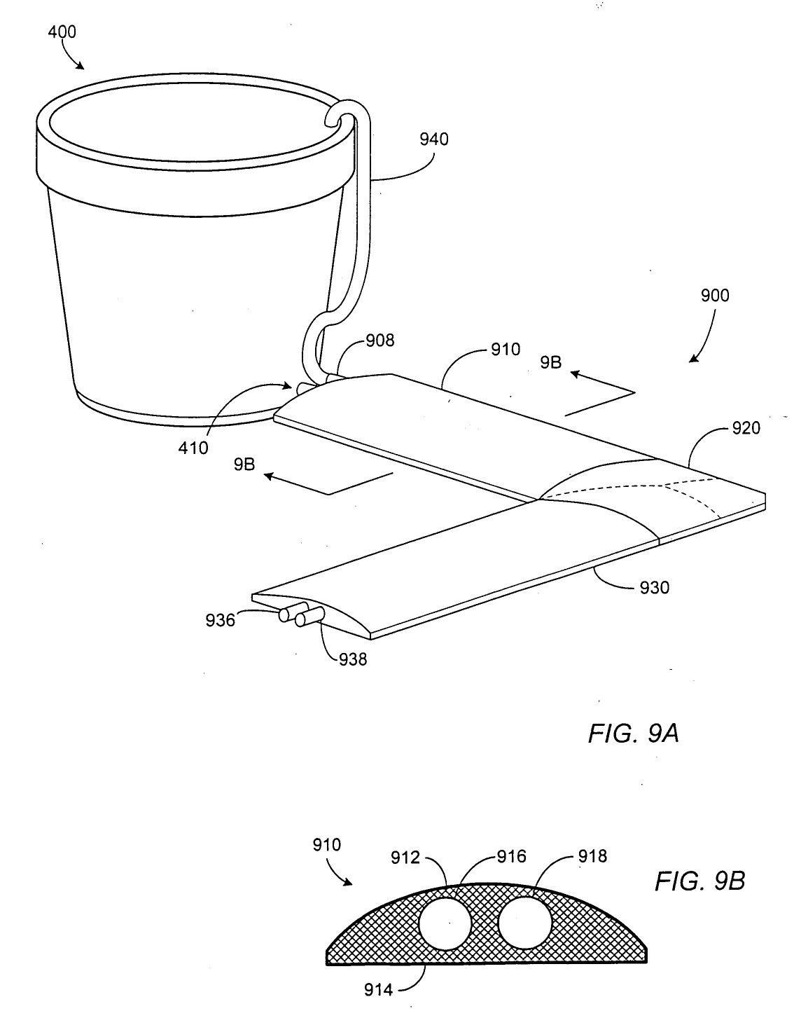

Referring now to FIGS. 9A and 9B, a planter 400 is shown having a two-way drain/supply system 900 that supplies water to the planter from a water source such as a sprinkler system and drains excess water away from the planter. A drain/supply tube 910 is shown in FIG. 9B in a sectional view taken along the lines 9B-9B in FIG. 9A, and is configured as having a low-profile, curved upper surface 912, a generally planar lower surface 914, and two hollow passageways or conduits 916, 918 within. A first hollow passageway 916 may be used for drainage to conduct excess water away from the planter 400 as described hereinbefore. A second hollow passageway 918 may be used to supply water to the planter, being connected to a source of water such as a sprinkler system.

As shown in FIG. 9A, a first straight-section drain/supply tube 910 is connected to the planter 400 at the drain apparatus 410. The first drain/supply tube 910 is coupled to a second drain/supply tube 930 by a 90-degree flat-corner drain/supply tube 920. Additional sections of drain/supply tube may be connected in a manner similar to that shown in FIG. 6A and FIG. 6C using fittings such as drain fitting 936 and supply fitting 938 (FIG. 9A). Excess water from the planter 400 may exit the drain passageway 916 through fitting 936. The supply passageway 918 may be connected to a source of water via supply fitting 938. Water from the source is then delivered to the planter via an irrigation tube 940 connected to a fitting 904 inserted in the supply passageway 918 of the drain/supply tube 910. The irrigation tube 940 is routed up the side of planter 400 to deliver water to the planter 400.

The use of planter systems according to the present invention and as shown in FIGS. 1-5 and 7-8 eliminates the problems associated with over-watering a potted plant by conducting excess water to an exit at which may be connected drainage tubing for conducting the excess water away from the planter system. A particular drainage tubing system as shown in FIGS. 6A-6C conducts water away from planter systems according to the present invention and is suitable for use across walkways, patios and the like. A two-way drain/supply tubing system as shown in FIG. 9 supplies water to the planter and drains excess water away from the planter.

It is understood that the present invention can take many forms and embodiments. Accordingly, several variations may be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1-14. (canceled)

15. An apparatus for managing excess water applied to a planter, comprising:
a) a bottom portion having an upper surface and a lower surface;
b) one or more side walls, extending upwardly from the bottom of the apparatus to form a container;
c) a drain formed in said upper surface, at or below the level of the upper surface of the bottom of the apparatus, said upper surface sloping downward toward said drain;
d) a passageway connecting said drain to an exit; and
e) at least one raised surface for supporting the planter above the upper surface of the bottom of the apparatus.

16-17. (canceled)

18. The apparatus of claim 15 wherein the apparatus is formed of a substantially waterproof material.

19. The apparatus of claim 18 wherein the waterproof material selected from the group comprising polypropylene, polyurethane, polycarbonate, or UBS plastic.

20. The apparatus of claim 15 wherein the apparatus is provided with a fitting at said exit for connecting a drainage tube.

21. The apparatus of claim 20 wherein said drainage tube has a generally planar lower surface and a generally curved upper surface, said upper surface having a low profile, and said drainage tube having a hollow passageway for conducting water away from said apparatus.

22-28. (canceled)

29. The apparatus of claim 15, wherein said passageway extends through the bottom portion of said apparatus connecting said drain opening to the exit at a side of the bottom portion of the apparatus.
